(19) United States
(12) Patent Application Publication
(10) Pub. No.: US 2010/0266865 A1
(43) Pub. Date: Oct. 21, 2010

(54) NICKEL BASED ALLOYS TO PREVENT METAL DUSTING DEGRADATION

(75) Inventors: Krishnamurti Natesan, Naperville, IL (US); Zuotao Zeng, Woodbridge, IL (US)

Correspondence Address: FOLEY & LARDNER LLP, 321 NORTH CLARK STREET, SUITE 2800, CHICAGO, IL, 60654-5313, US

(73) Assignee: U Chicago Argonne LLC

(21) Appl. No.: 11/943,438

(22) Filed: Nov. 20, 2007

Related U.S. Application Data
(62) Division of application No. 11/443,566, filed on May 31, 2006, now abandoned.
(60) Provisional application No. 60/686,480, filed on Jun. 1, 2005.

(51) Int. Cl. B32B 1/08; C22C 19/05; B32B 15/01

(52) U.S. Cl. 428/586; 420/443; 420/445; 420/446

(57) ABSTRACT

An article of manufacture for reducing susceptibility of a metal pipe to metal dusting degradation. The article includes a multi-layer tubing having an alloy layer and a copper layer. The alloy layer can include a Ni based, an Al based and an Fe based alloy layer. In addition, layers of chrome oxide, spinel and aluminum oxide can be used.

This application is a Divisional Application of U.S. patent application Ser. No. 11/443,566, filed May 31, 2006, which claims priority to U.S. Provisional Patent Application No. 60/686,480, filed on Jun. 1, 2005 and incorporated herein by reference.

The United States Government has certain rights in the invention pursuant to Contract No. W-31-109-ENG-38 between the U.S. Department of Energy and the University of Chicago operating Argonne National Laboratory.

### BACKGROUND OF THE INVENTION

This invention relates to a method of manufacture and alloy composition for preventing metal dusting degradation. More particularly the invention relates to nickel-based alloys with aluminum addition and also to the use of a copper-based layer to prevent metal dusting-corrosion.

Metal dusting is a catastrophic corrosion phenomenon that leads to the deterioration of structural metals and alloys into a dust composed of fine particles of the metal/alloy and carbon. This is usually a localized form of attack and occurs at intermediate temperatures of about 350°-800° C. However, this type of corrosion is possible at any temperature when the carbon activity (a_{c}) in the gas phase is >>1. Metal dusting corrosion occurs in many metallic alloys, particularly Fe-, Co- and Ni-base alloys, when exposed to carbonaceous atmospheres. Under these conditions, the alloys undergoing metal dusting develop pits and holes on the surface, and then disintegrate into a powdery mixture of carbon, oxides, carbides, and fine metal particles. Metal dusting is a more severe problem than carburization since process equipment or component piping will be functionally inoperative from damage occurring when alloys become fine powder.

Petroleum refineries are one example of industrial environments which need to operate in high carbon activity environments; and as a result, the equipment experiences metal wastage in processes involving hydro-dealkylation and catalyst re-generation systems. Metal wastage also occurs in direct iron-ore reduction plants wherein reformed methane is dried and reheated to enhance ore-reduction efficiency. The ammonia synthesis process also shows metal wastage in the heat-recovery section of the reformed-gas system as well as in the reformer itself. Gases used in heat-treating mixtures contain oil residue on items to form gases that are chemically favorable for metal dusting. Gas mixtures used for carburizing can also cause metal wastage if control of chemistry is not managed. Therefore, the heat-treat industry also suffers metal wastage problem. Other example processes wherein metal wastage occurs are nuclear plants that employ carbon dioxide for cooling the recycle gas loop equipment of coal-gasification units, iron-making blast furnaces in steel mills, and fuel cells that use hydrocarbons.

Metal dusting usually occurs at temperatures as low as 350° to about 800° C. In a hydrogen plant, hot carbon bearing gases are produced primarily by steam reforming and partial oxidation of hydrocarbon at temperatures of 800-1000° C. These gases have to be quenched to 300° C. to avoid metal dusting in the temperature window 400-800° C. Energy in high temperature syngas is not recovered in an efficient manner. Plant production is generally affected by unforeseen shut-downs due to metal wastage problem. Therefore, it is necessary to develop new methods to prevent this metal dusting problem in the temperature window from about 350° to 800° C.

There are conventional techniques to try to reduce metal dusting by coating construction materials with thin layers of copper which are described in US005676821A. The coatings, in general, contain microporosity which can enable the reactive gases to permeate and degrade the integrity of the thin coating layers. It has been shown that carburizing gas can slowly diffuse through the coating layer and eventually lead to failure of the protective coating. This simple coating approach, even though beneficial in short term, is generally not amenable to prevent metal dusting over long term in the service of metallic structures in process plants.

Oxide scales also can play a role in preventing alloys from metal dusting corrosion since carbon diffuses much more slowly through the oxide layers, especially if defects such as pores and cracks are not present in the oxide layers. Because oxide scales are potentially useful in preventing metal dusting corrosion, it is important to consider further the role of their composition and microstructural characteristics in the initiation and propagation of metal dusting. However, the composition and phases present in oxide scales have been rarely investigated and thus not well understood since the oxide layer, generally, is too thin to detect and analyze by conventional X-ray methods.

Copper-aluminum, copper-silicon alloys are also proposed as construction materials to resist metal dusting corrosion (see, for example, WO03072836). However, the mechanical strength of these materials are too low at high temperature for their use as monolithic structural materials for long term service. Many industrial processes involve high pressures and elevated temperatures. Therefore, new approaches are needed to resist metal dusting corrosion of metallic structures for service at high temperatures and high pressures over long term periods of interest in the industrial sector.

### SUMMARY OF THE INVENTION

While not meant to limit the scope of the invention, it is believed that metal dusting is due to the crystallization of carbon inside the substrate alloys. Carbon diffuses into alloys after it deposits on a surface by catalytic reaction of the gas phase constituents. Carbon then finds a special facet of microcrystal in a metal and precipitates inside the metal, and this process leads to the separation of metal particles. The bulk alloy then finally separates into fine particles and/or metal dust. Whenever carbon diffuses into the alloy, metal dusting is difficult to stop, and an effective way to prevent metal dusting is to build a dense barrier on a surface of metal and minimize carbon diffusion. If carbon cannot diffuse through the barrier, metal dusting corrosion, generally, does not happen. Usually, alloys develop an oxide scale on its surface to prevent metal dusting, and the diffusion rate of carbon in oxide is very low. However, carbon atoms still can diffuse through the defects in oxide scale and reduce the Fe-containing spinel phase to form channels for carbon diffusion. Whenever the channels form, there is no way to stop the diffusion of carbon into alloys. This process leads to initiation and propagation of pitting corrosion.

Copper specimens have been tested in several forms by exposing them in a metal dusting environment at various temperatures. Copper was found to be noncatalytic for carbon deposition. Almost no deposit of carbon was observed in these experiments. The copper was also combined with another metal/metal alloy layer to form a bimetallic barrier layer combination.

The solubility and diffusion rate of carbon in copper are low. Therefore, copper is an excellent material to prevent metal dusting. However, the mechanical strength of copper at high temperature is too low. It is thus difficult to directly use pure copper as a structural material at elevated temperatures. Most of the materials used in metal dusting environment are in the form of vessels, tubing, and piping. Therefore, bimetallic tubing was prepared with an inner copper tubing and an outer Fe or Ni-base alloy tubing to prevent metal dusting corrosion. This dense copper layer on the inside diameter stops the formation/deposit of carbon and also stops the diffusion of carbon, thereby preventing the outer alloy tube from metal dusting corrosion.

The present invention also relates to several Ni-base alloys as materials for use to provide superior resistance to metal dusting degradation when exposed to highly carbonaceous gaseous environments that are prevalent in hydrogen-, methanol-, and ammonia-reformers and in syngas plants. In addition, the alloys developed have adequate strength properties for use as monolithic structural materials in the chemical, petrochemical, and syngas plants at temperatures up to 900° C. The alloys developed have composition ranges (in wt. %) as follows: C 0.02-0.2, Cr 22-29, Al 2.3-3.3, Fe 0-1, Ti 0.3, Zr 0.1-0.2, Y 0-0.1, Balance Ni (all ranges are approximate). The Ti, Zr and C additions are made to control the carbide precipitation and thereby improve the mechanical strength properties at elevated temperatures. Zr and Y additions also contribute to improve the adhesion of the oxide scale to the substrate alloy. The Cr and Al additions in the alloy greatly assist in resisting metal dusting.

### BRIEF DESCRIPTION OF THE DRAWINGS

FIG. 1 illustrates a schematic drawing of a cross section of a bimetal (Cu/Fe or Ni based alloy) tubing;

FIG. 2A illustrates alloy 800 after exposure in a carburizing gas for 3700 h and

FIG. 2B illustrates alloy 321 after exposure in a carburizing gas for 3700 h;

FIG. 3 illustrates a 3D-profile mapping of corrosion pits in alloy 800 tested in a metal dusting environment at 593° C. for 150 h;

FIG. 4 illustrates an SEM image of Type 321 stainless steel tested in a metal dusting environment at 593° C. for 1100 h;

FIG. 5A illustrates an iron specimen with a 0.8 mm Cu-cladding tested in a metal dusting environment at 593° C. for 600 h, and FIG. 5B illustrates a base iron coupon tested under the same conditions as the specimen of FIG. 5A;

FIG. 6 illustrates weight change data for copper and iron based alloys after exposure in Gas No. 11 at 593° C. and 1 atmosphere pressure;

FIG. 7 illustrates copper and nickel based alloys exposed to Gas No. 14 at 593° C. at 1 atmosphere pressure;

FIG. 8 illustrates Raman shift versus intensity for a simulated fit of a broad band for Alloy 153MA with Cr₂O₃ and spinel Raman bands superimposed on the broad band;

FIG. 9 illustrates weight change data for various (Fe, Cr) spinel phases and (Ni, Cr) spinel phase during exposure in a metal dusting gas mixture at 593° C.;

FIG. 10 illustrates X-ray diffraction data for FeCr₂O₄ and other oxides for Alloy 800 after exposure in a carburizing gas consisting of vol. %: 66.2H₂-7.1 CO₂-23 CO-1.4 CH₄-2.3H₂O at 593° C. for 1000 h;

FIGS. 11A-11D illustrate Raman data for different Alloys 253MA, 153MA, T91 and T22 after exposure in a carbonizing gas consisting of vol. %: 52H₂-5.6 CO₂-18 CO-1.1 CH₄-23H₂O at 593° C. for 1000 h;

FIG. 12 illustrates Raman spectra of Alloys 253MA and 601;

FIG. 13 illustrates Raman spectra of Alloys 310 and 602CA;

FIG. 14 illustrates Raman spectra of Alloy 601 exposed in a carburizing gas consisting of vol. %: 53.4H₂-18.4 CO-5.7 CO₂-22.5H₂O at 593° C. at 200 psi for 100 and 2900 h;

FIG. 15 illustrates Raman spectra of Alloy 690 exposed in a carburizing gas consisting of vol. %: 53.4H₂-18.4 CO-5.7 CO₂-22.5H₂O at 593° C. at 200 psi for 100 and 2900 h;

FIG. 16 illustrates Raman spectra of Alloy 45™ exposed in a carburizing gas consisting of vol. %: 53.4H₂-18.4 CO-5.7 CO₂-22.5H₂O at 593° C. at 200 psi for 100 and 2900 h;

FIG. 17 illustrates thermal stability of spinel and Cr₂O₃ phases in Gas 10 consisting of (in vol %) 53.5H₂-18.4 CO-5.7 CO₂-22.5H₂O.

FIG. 18A illustrates schematically a mechanism for diffusion of carbon and metal dusting of an alloy without presence of Al in the alloy and FIG. 18B with the presence of Al in the alloy;

FIG. 19 illustrates a schematic of a high pressure, high temperature test facility;

FIG. 20A illustrates an SEM micrograph of Alloy 601 after exposure to a metal dusting environment at 14.3 atmosphere and 593° C. for 160 h; FIG. 20B is Alloy 601 at 1 atmosphere and 593° C. for 240 h; FIG. 20C is for Alloy 690 at 14.3 atmosphere and 593° C. for 160 h; FIG. 20D is for Alloy 690 at 1 atmosphere at 593° C. for 240 h; FIG. 20E is for Alloy 617 for 14.3 atmosphere and 593° C. for 160 h; FIG. 20F is alloy 617 at 1 atmosphere and 593° C. is for 240 h; FIG. 20G is for Alloy 214 at 14.3 atmosphere and 593° C. for 160 h; and FIG. 20H is for Alloy 214 at 1 atmosphere and 593° C. for 240 h;

FIG. 21 illustrates weight loss data for several Ni-based alloys (see inset lists of alloys) after exposure in a metal dusting environment at 593° C. and 14.3 atmosphere;

FIG. 22A illustrates an SEM micrograph of Alloy 45™ showing pit size variation after 1540 h; with FIG. 22B after 2180 h; FIG. 22C after 2500 h; and FIG. 22D after 3300 h; FIG. 22E is for alloy 690 after 2900 h; with FIG. 22F after 4100 h; FIG. 22G after 7300 h and FIG. 22H after 9300 h; FIG. 22I is for alloy 617 after 2900 h; with FIG. J after 4100 h; FIG. 22K after 7300 h and FIG. 22L after 9300 h;

FIGS. 23A-23G illustrate correlation of weight loss and variation in corrosion pit size for a single pit on the surface of the indicated alloy series as a function of exposure time at 593° C. in a metal dusting environment;

FIGS. 24A-24H illustrate 3D-profile mapping of the surface of the indicated Ni-based series of alloys after 9700 h exposure in a metal dusting environment at 593° C. and 14.3 atmospheres;

FIGS. 25A-25H illustrate Raman spectra for the indicated Ni-based series of alloys after 2900 h exposure in a metal dusting environment at 593° C. and 14.3 atmosphere;

FIG. 26 illustrates thermal stability of various indicated spinel and Cr₂O₃ phases; and

FIG. 27A illustrates Raman spectra of Alloy N06601 after exposure for 100 h and 2900 h for 593° C. in a metal dusting environment at 593° C., FIG. 27B for N07790, FIG. 27C for 617, FIG. 27D for 45™, FIG. 27E for 625; FIG. 27F for 214; FIG. 27G for HR160 and FIG. 27H for 693.

### DETAILED DESCRIPTION OF THE PREFERRED EMBODIMENTS

### Multi-Layer Metal Tubing

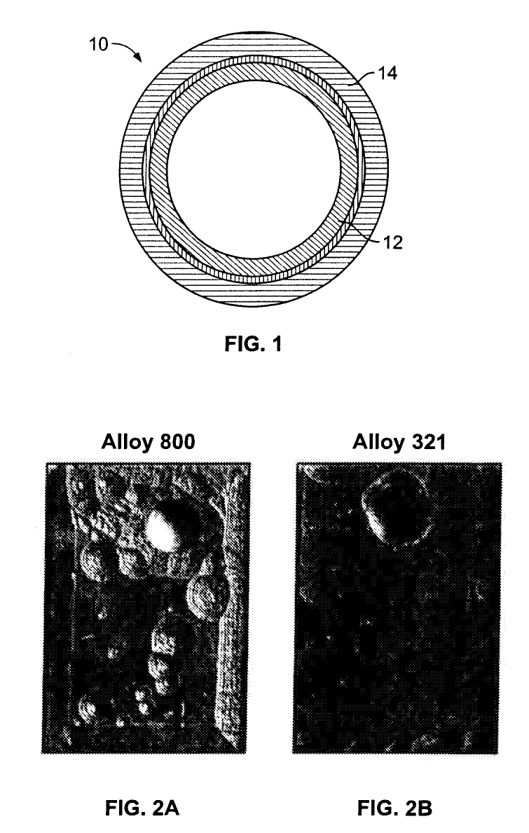

In a first embodiment of the invention a multi-layer metal tubing is illustrated schematically in FIG. 1 at 10. The most preferred form of the invention constitutes a bi-metal Cu/Fe or Ni based alloy. The thickness of copper and copper alloy tubing is >0.1 mm. It can be preferably bonded or fabricated without bonding between copper inner tubing 12 and outer alloy tubing 14. Bonding is better because carburizing gas cannot diffuse through between the two tubes in case there is a defect in the copper tubing 12. To bond the copper tubing 12 together, a thin layer of low melting temperature metals or their mixtures such as zinc, silver, tin, and cadmium, were coated either on outer surface of the copper tubing 12, or on the inner surface of the alloy tubing 14, or both surfaces. High temperature and pressure were applied to bond the tubes together.

Experiments were conducted in a horizontal furnace with a quartz tube (2 in dia.) at 1 atm and in a tube furnace at high pressures. The test temperature was 593° C. (1100° F.). The experiments are conducted in several gas mixtures and at several system pressures. Some samples were tested for >10000 h. The composition of test gases used for the evaluation is shown in Table 1.

TABLE 1
Chemical compositions of gas mixture
relevant for metal dusting study.

| | H₂ | Cₒ | C0₂ | H₂0 | CH₄ | |
|---|---|---|---|---|---|---|
| Gas | (mol %) | (mol %) | (mol %) | (mol %) | (mol %) | Other (mol %) |
| 1 | 43.8 | 7.2 | 5.7 | 39.2 | 4.1 | — |
| 2 | 52 | 18 | 5.6 | 23 | 1.1 | — |
| 2b | 66.2 | 23 | 7.1 | 2.3 | 1.4 | — |
| 3 | 36.3 | 8.4 | 5.6 | 35 | 0.2 | N₂ 15, Ar 0.1 |
| 4 | 74.2 | 17.5 | 8.3 | 0 | — | — |
| 5 | 72.2 | 17.6 | 8.3 | 2.0 | — | — |
| 6 | 77.2 | 12.7 | 10.1 | 0 | — | — |
| 7 | 25.3 | 70 | 4 | 0.01 | — | — |
| 8 | 71.4 | 11.3 | 17.4 | 0 | — | — |
| 9 | 71 | 11.7 | 17.3 | 0 | — | — |
| 10 | 53.4 | 18.4 | 5.7 | 22.5 | — | — |
| 11 | 79.5 | 18.2 | — | 2.3 | — | — |
| 12 | 75.4 | 6.2 | 18.4 | — | — | — |
| 13 | 71.0 | 2.6 | 26.4 | — | — | — |
| 14 | 40 | 45 | 5 | 10 | — | — |
| 15 | 20 | 65 | 5 | 10 | — | — |
| 16 | 40 | 25 | 25 | 10 | — | — |
| 17 | 20 | 74.5 | 5 | 0.5 | — | — |

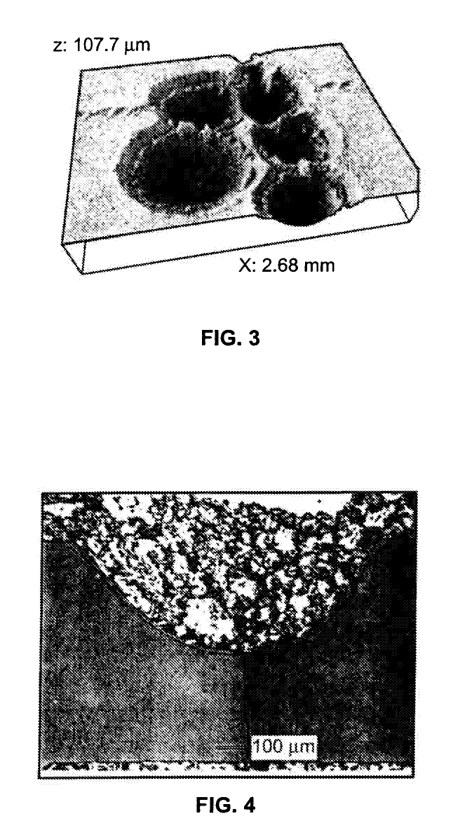

Table 2 shows that copper and copper alloy specimens were resistant to degradation by metal dusting. However, most of the state-of-the-art, commercial and experimental Fe- and Ni-base alloys were attacked in the same environment. FIGS. 2 and 3 show pits that were observed on surfaces of Alloys 800 and 321 stainless steel after exposure in metal dusting environment. FIG. 4 shows that a deep pit that developed in Alloy 321. In Alloy 800, carbon was heavily deposited on the surface and metal dusting pits were observed, whereas, carbon neither was visually observed on the copper sample, nor was detected by X-ray diffraction. This indicates that copper did not catalyze the gas phase reaction to deposit carbon. Therefore, the carbon growth rate on copper was extremely low.

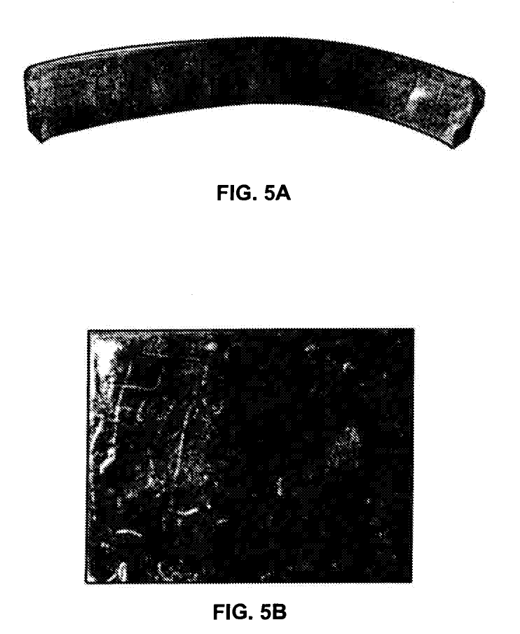

FIG. 5A shows the surface of the copper-clad iron specimen after exposure to metal dusting environment at 593° C. The surface was clean and devoid of any deposit of carbon. The clad specimen did not lose weight after metal dusting test. However, the surface of the bare (un-clad) iron specimen of FIG. 5B was covered by carbon after metal dusting exposure for only 100 h

iron was consumed at a rate of 0.55-mg/cm²-h. The test results indicate that application of a dense copper clad >0.1 mm on the alloy surface prevented metal dusting attack.

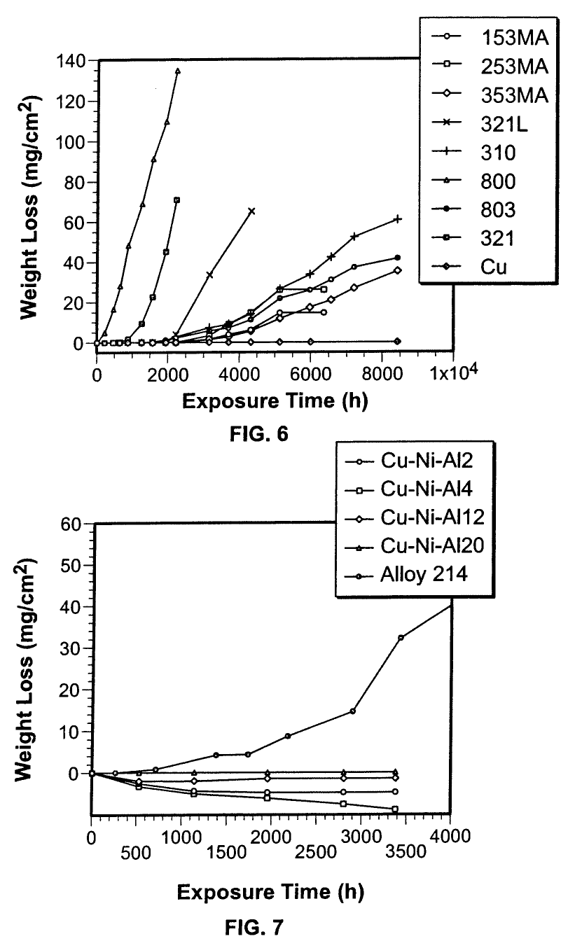

FIG. 6 shows a series of metals and metal alloys (alloy key in the inset box). FIG. 6 indicates copper was not attacked by metal dusting even after exposure for >7000 h. However, other Fe-base alloys lost weight significantly during the same exposure period. Copper alloys also showed strong resistance to metal dusting. No weight losses were observed for these alloys after 3000 h exposure to carburizing gas. Meanwhile, Ni-base Alloy 214 severely lost weight (see FIG. 7).

TABLE 2
Metal dusting experimental results for Cu alloys

| Exp. | | Gas | Time | Pressure | |
|---|---|---|---|---|---|
| # | Material | # | (h) | (atm) | Results |
| 33 | Cu coated iron and | 4 | 163 | 1 | Clean surface |
| | alloys | | | | |
| 35 | Cu clad Fe plate | 4 | 784 | 1 | Clean surface |
| 36 | Glidcop | 4 | 144 | 1 | Clean surface |
| 37 | Cu coated iron and | 4 | 120 | 1 | Clean surface |
| | alloys | | | | |
| 41 | Cu | 8 | 100 | 27 | Clean surface |
| 42 | Cu | 8 | 100 | 14 | Clears surface |
| 43 | Cu | 13 | 100 | 41 | Clean surface |
| 45 | Glidcop | 4 | 300 | 1 | Clean surface |
| 49 | Cu | 10 | 1131 | 14 | Clean surface |
| 50 | Cu | 10 | 100 | 14 | Clean surface |
| 51 | Cu | 10 | 113 | 41 | Clean surface |
| 52 | Cu | 10 | 680 | 41 | Clean surface |
| 53 | Cu | 11 | 8348 | 1 | Clean surface |
| 54 | Cu | 14 | 1950 | 1 | Clean surface |
| 56 | Cu—Ni-A1 2 | 14 | 10027 | 1 | No weight loss |
| 56 | Cu—Ni—Al 4 | 14 | 10027 | 1 | No weight loss |
| 56 | Cu—Ni-AI 12 | 14 | 10027 | 1 | No weight loss |
| 56 | Cu—Ni-A1 20 | 14 | 10027 | 1 | No weight loss |
| 59 | Cu—Ni-A1 2 | 10 | 8900 | 14 | No weight loss |
| 59 | Cu—Ni-A1 4 | 10 | 8900 | 14 | No weight loss |
| 60 | Cu | 10 | 246 | 1 | Clean surface |

B.—Nickel-Base Alloys with Low Iron Content

Extensive studies were conducted on metal dusting with a variety of commercial Fe- and Ni-base structural alloys in environments that simulate reformer environment. Alloys generally develop oxide scales in the exposure environment, but depending on the phases present in the oxide scales in the reduction of these phases, lead to nucleation and growth of pits leading to catastrophic failure of the alloy into powder. The characteristics of different oxide scales were examined and also correlated the information with the compositions of the alloys and their resistance to metal dusting.

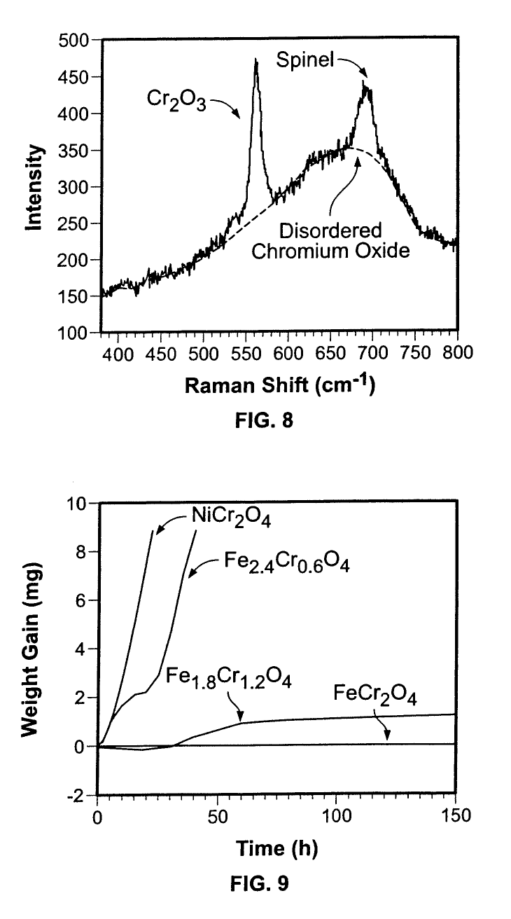

It was determined that diffusion of carbon through oxide scale is difficult. However, Fe-, Co, and Ni-base alloys cannot avoid metal dusting corrosion if high activity carbon diffuses into the alloys. Therefore, the quality of the oxide scale is very important for alloys to resist metal dusting corrosion. Raman experiments show there are three types of oxides in oxide scale, which are Cr₂O₃, disordered chromium oxide, and Fe₁₊ₓCr₂₋ₓO₄ (0≦x≦1) spinel (FIG. 8).

To study the reaction of these oxides with carburizing gas, Cr₂O₃, (Fe, Cr)₃O₄ spinel, and Cr metal were tested in a carburizing gas consisting of (in vol. %) 52H₂-5.6 CO₂-18CO_{1.1}CH₄-23H₂O at 593° C. in a thermo gravimetric test apparatus. Disordered chromium oxide and Cr₂O₃ formed on the surface of Cr metal. Weight gains of FeCr₂O₄, Cr₂O₃, and Cr metal were almost zero. Although the carbon activity of the carburizing gas consisting of (in vol. %) 52H₂-5.6CO₂-18CO_{1.1}CH₄-23H₂O was >1 at 593° C., the deposition of carbon on Cr₂O₃, disordered chromium oxide, and FeCr₂O₄ is difficult since the activation barrier is high for the following reactions:

CO+H₂═C+H₂O (1)

2CO═C+CO₂ (2)

If the alloy surface is totally covered by Cr₂O₃, disordered chromium oxide, and FeCr₂O₄, carbon deposition and metal dusting may not occur. However, weight gain was observed for Fe_{1.8}Cr_{1.2}O₄, and the carbon deposition rate in Fe_{2.4}Cr_{0.6}O₄ was much larger than that of Fe_{1.8}Cr_{1.2}O₄ (FIG. 9). Therefore, spinel with high iron content seems to catalyze reaction 1 and/or 2, which leads to deposition of carbon.

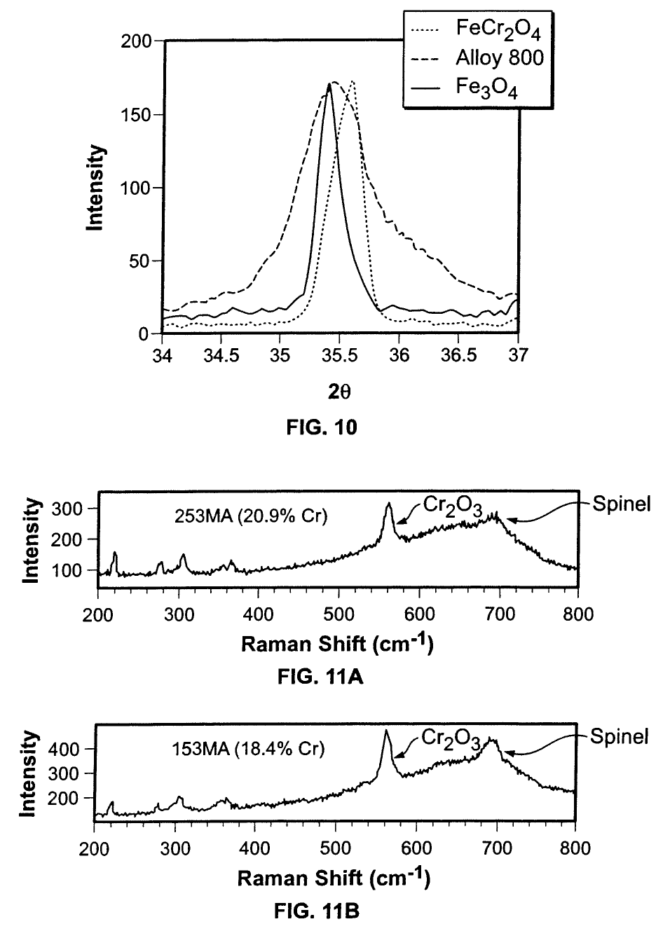

Cr₂O₃ is stable in carbon and hydrogen atmospheres down to very low PO₂. This oxide is an excellent protective layer in preventing alloys from metal dusting corrosion. Fe(Cr₁₋ₓFeₓ)₂O₄ spine, on the other hand, is not as stable as Cr₂O₃. The composition of the spinal can vary from FeCr₂O₄ [x=0 in Fe(Cr₁₋ₓFeₓ)₂O₄] to Fe₃O₄ (x=1). As mentioned above, Fe₃O₄ is not stable when the H₂O concentration is low. The stability of FeCr₂O₄ is higher than that of Fe₃O₄, but lower than that of Cr₂O₃. If there are no defects such as nonuniform distribution of cations, FeCr₂O₄ should be stable in a carburizing gas. However, it has been reported that FeCr₂O₄ starts to be partially reduced by carbon at 600° C. FIG. 10 shows that the X-ray peak position of the spinal on the surface of Alloy 800 is between Fe₃O₄ and FeCr₂O₄, and the peak is also much broader than that of polycrystalline Fe₃O₄ and FeCr₂O₄. Thus, it appears the spinal on the surface of alloy is not stoichiometric FeCr₂O₄, but has higher iron content and such a spine is likely susceptible to reduction by carbon.

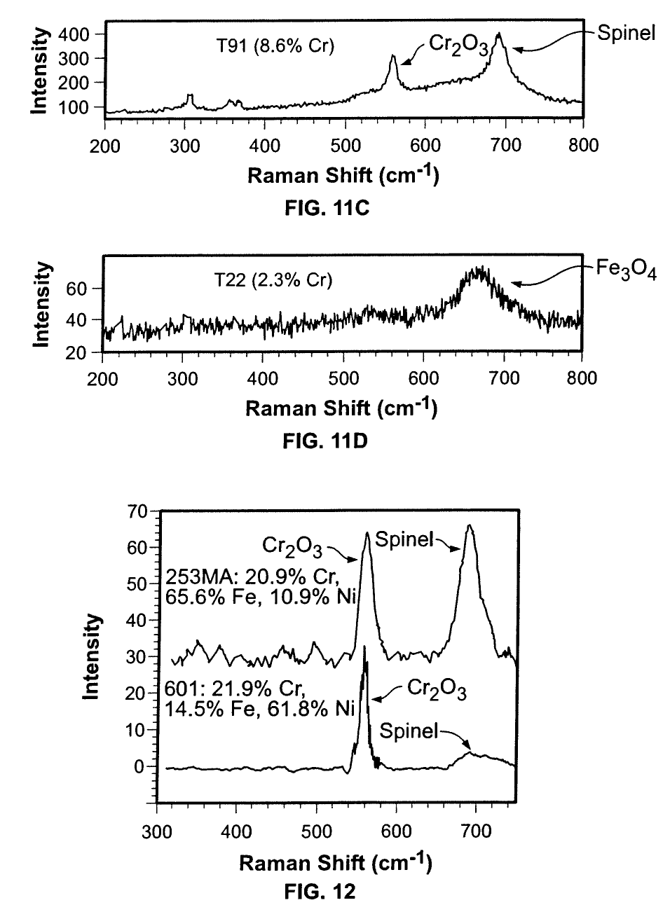

The higher the concentration of iron in Fe(Cr₁₋ₓFeₓ)₂O₄, the easier is the spinel reduction. The ratio of Fe/Cr in spinel may vary with oxygen partial pressure in gas. When PO₂ in gas, such as in Gas 1, is higher than 7×10⁻²⁶ atm, the most unstable spinel Fe₃O₄ could form, which could be attacked by carbon leading to metal dusting corrosion of the underlying alloy. It is difficult to measure the iron content in the oxide layer because it is too thin. However, the iron content in the oxide scale increases with increasing iron content in the alloy. Furthermore, the iron concentration may not be uniform in the oxide scale. Some spots with high iron content may react with carbon first and metal dusting will start from those regions. FIG. 11B shows that alloy 153MA has less spinel phase in the oxide scale than does T91; therefore, 153MA has fewer defects susceptible to attack by metal dusting corrosion than does alloy T91 of FIG. 11C. This is also consistent with the observation of smaller mass loss for 153MA than that for T91.

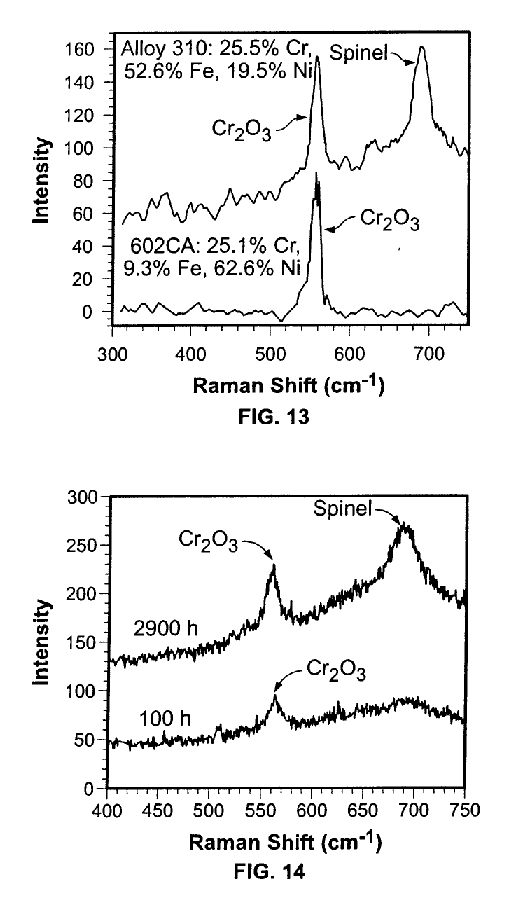

FIGS. 12 and 13 show the differences in Raman spectra for two pairs of alloys: Alloy 253MA and 601, and Alloy 310 and 602CA. These alloys were exposed for 1000 h to Gas 10 at 593° C. and 200 psi. The Cr content in Alloy 253MA (20.9%) and 601 (21.9%) is similar. However, the Fe-base alloy 253MA has a much stronger spinel peak than that of the Ni-base alloy 601 (FIG. 12). Pits were observed on Alloy 253MA, but not on Alloy 601 when exposed under the same experimental conditions. The Cr content in Alloy 310 (25.5%) and 602CA (25.1%) is also similar. FIG. 13 shows the strong spinel peak for the Fe-base Alloy 310, but almost no such peak for the Ni-base Alloy 602CA. Pits were again observed only on Alloy 310, but not on Alloy 602CA. Less spinel in the oxide scale of Ni-base alloys only means that the development of spinal takes a much longer time and that the incubation time for metal dusting initiation is much longer. However, the presence of Fe, even in low concentration, in Ni-base alloys will lead to metal dusting degradation during years of service planned for these structural components in reformer environments.

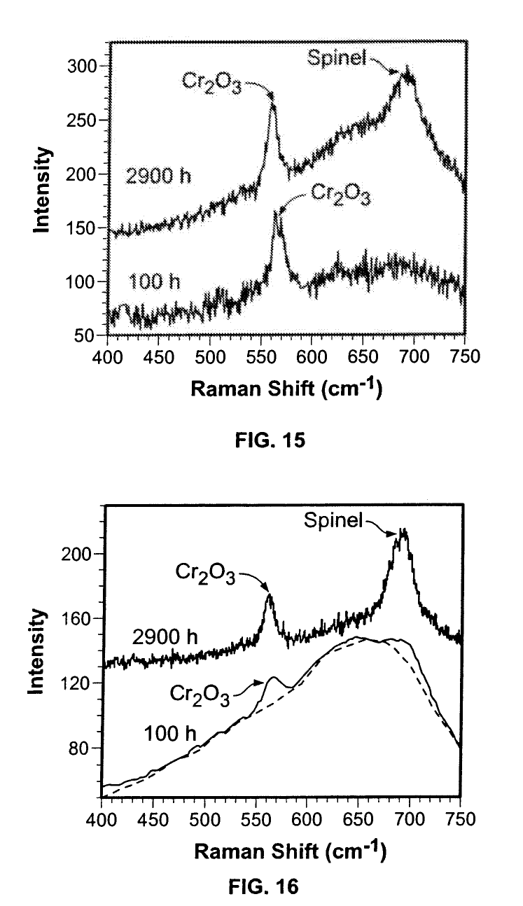

Phase composition of oxide scales that developed on surface of alloys changes with exposure time. FIGS. 14 to 16 (601, 690, 45™) show the intensity differences of Raman bands for Cr₂O₃ and spinel phases in oxide scale on surfaces of several alloys. When the alloys were exposed for only 100 h, Cr₂O₃ was the major phase in oxide scales that developed on surface of alloys. However, after 2900 h exposure, the intensity of spinel band in Raman spectra increased significantly.

The increasing amount of spinel phase in oxide scales over longer exposure time can be attributed to the outward diffusion of Fe from the alloy substrate. At early stages, Cr-rich oxide forms on the surface of alloys. However, as the outward transported Fe is incorporated into the scale, spinel phase becomes dominant as was observed in the Raman spectra. The diffusion rate of Fe and its incorporation in the scale to form the spinel phase would have a pronounced effect on the incubation time for the onset of metal dusting in the alloy. As the transported Fe is incorporated into the spinel phase, the protective capacity of the spinel is reduced, since the inward migrating carbon can easily reduce the high-iron-containing spinel (as discussed earlier).

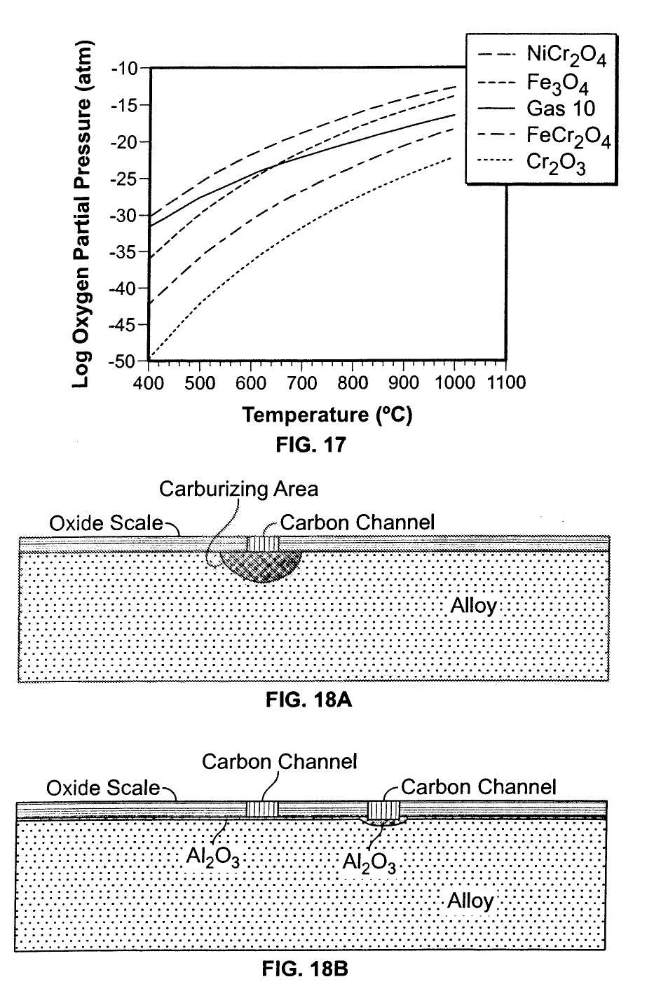

Raman spectra showed that the intensity of Cr₂O₃ band at ≈560 cm⁻¹ was low for Alloy 45™ and the relative intensity of spinel is high. As was discussed earlier, spinal phase in the scale is not as good as Cr₂O₃ scale in preventing alloys from metal dusting corrosion, which probably is the cause for the alloy to undergo metal dusting. The Cr content in 45™ is relatively high but the Fe content is also high. The presence of high Fe content may stabilize the Fe-containing spinal phase rather than Cr₂O₃, thereby subjecting the alloy to metal dust. NiCr₂O₄ spine is not thermodynamically stable in a reducing environment used in our study and therefore, could not form at 593° C. (see FIG. 17). The results suggest that an alloy with a high Cr content (with or without Al) and almost no Fe content may stabilize Cr₂O₃ and/or a spinal phase with high Cr content, thereby prolong the incubation period for the onset of metal dusting and subsequent propagation of the process leading to metal wastage. Even small addition of iron will affect the quality of oxide scale and decrease the ability of alloys to resist metal dusting.

FIGS. 18A and 18B are schematic representations of a non-limiting mechanism that explains the function of aluminum in the resistance of alloys to metal dusting corrosion. Physical defects may be present in oxide scales that develop on the surface of alloys. When carbon deposits on these surfaces during exposure to a metal dusting environment, carbon diffuses through these defects and reduces the spinel phase to Fe₃C and/or Ni metal. These particles form channels for transferring carbon through the oxide scale. Oxygen may also diffuse through these channels leading to the formation of additional Cr oxide and slowing the diffusion of carbon. However, the carbon diffusion rate is probably higher than that of oxygen and formation of additional Cr oxide beneath the carbon channel may not be feasible. Therefore, carbon can continue to diffuse into alloys through the channels and finally form metal dusting pits. When Al is added to the alloy, alumina scale usually forms under the Cr oxide scale. The alumina may affect resistance to metal dusting corrosion in two ways. First, the carbon transferred through the channel may not be able to penetrate through the alumina layer because alumina is much more stable than spinel. Second, the partial pressure of oxygen needed to form Al₂O₃ (3.6×10⁻⁵⁷ atm) is much lower than that needed to form Cr₂O₃ (2.6×10⁻³⁷ atm) at 593° C. A thin layer of alumina scale can form (even with limited oxygen transport through the channel) beneath the carbon diffusion channel, and thereby reduce the growth of metal dusting pits.

Various non-limiting examples are provided hereinafter and are based on the following experimental procedure:

### EXAMPLES

The test program included eight Ni-base wrought alloys, predominantly those which are commercially available. Table 3 lists the nominal chemical compositions of the alloys. The alloys had complex chemical compositions and contained Cr (in a range of 15.4-28 wt. %) and several other elements, such as Mo [alloy 617 (UNS N06617)], Al [601 (UNS N06601), 617 (UNS N06617), 602CA (UNS N06025), 214 (UNS N07214), and 693 (UNS N06693)], and Si [45™ (UNS N06045) and HR 160 (UNS N12160)]. Alloy 690 (UNS N06690) containing 27.2 wt. % Cr, but without additions of Si, or Mo, or Al was also included in the study. Further, several alloys contained Nb, W, and Co, which can also influence the oxidation behavior of the alloys and their resistance to metal dusting attack.

TABLE 3
Nominal composition (in wt. %) of alloys selected for the study.

| Alloy | | | | | | | | | |
|---|---|---|---|---|---|---|---|---|---|
| UNS. | C | Cr | Ni | Mn | Si | Mo | Al | Fe | Other |
| N06601 | 0.03 | 21.9 | 61.8 | 0.2 | 0.2 | 0.1 | 1.4 | 14.5 | Ti 0.3, |
| | | | | | | | | | Nb 0.1 |
| N06690 | 0.01 | 27.2 | 61.4 | 0.2 | 0.1 | 0.1 | 0.2 | 10.2 | Ti 0.3 |
| N06617 | 0.08 | 21.6 | 53.6 | 0.1 | 0.1 | 9.5 | 1.2 | 0.9 | Co 12.5, |
| | | | | | | | | | Ti 0.3 |
| N06025 | 0.19 | 25.1 | 62.6 | 0.1 | 0.1 | — | 2.3 | 9.3 | Ti 0.13, Zr |
| | | | | | | | | | 0.19, Y 0.1 |
| N07214 | 0.04 | 15.9 | Bal | 0.2 | 0.1 | 0.5 | 3.7 | 2.5 | Zr 0.01, |
| | | | | | | | | | Y 0.006 |
| N06045 | 0.08 | 27.4 | 46.4 | 0.4 | 2.7 | — | — | 26.7 | RE 0.07 |
| N12160 | 0.05 | 28.0 | Bal | 0.5 | 2.8 | 0.1 | 0.2 | 4.0 | Co 30.0 |
| N06693 | 0.02 | 28.8 | Bal | 0.2 | — | 0.1 | 3.3 | 5.8 | Nb 0.7, Ti |
| | | | | | | | | | 0.4, Zr 0.03 |

The samples were flat coupons with approximate dimensions of 12×20×1 to 2 mm. They were sheared slightly oversize, and their edges were milled to remove cut edges and reduce the coupons to final size. A standard surface finish was used for all alloy specimens. The finish involved a final wet grinding with 400-grit SiC paper. Stenciling or electric engraving at the corner of the coupons identified all of the specimens. Prior to testing, specimens were thoroughly degreased in clean acetone, rinsed in water, and dried. The specimen dimensions were measured to +0.02 mm, and the total exposed surface area, including edges, was calculated. The specimens were weighed to an accuracy of 0.1 mg.

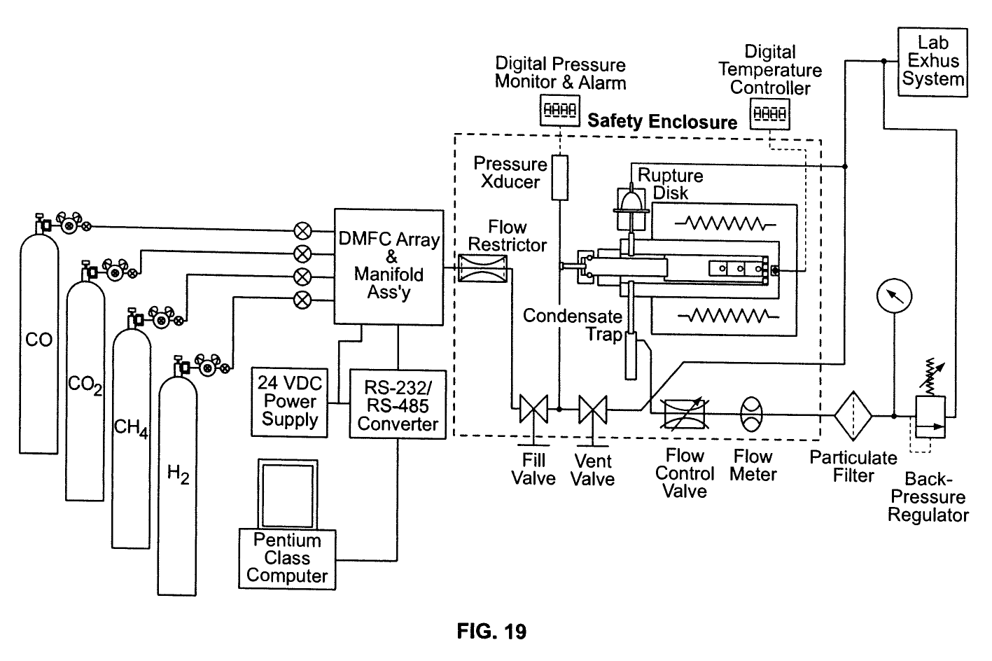

FIG. 19 shows a schematic of a system that was used to conduct experiments at system pressures up to 600 psi. The system consisted of a horizontal, tubular, high temperature furnace capable of operation up to 900° C. The reaction chamber, with gas inlet/outlet fittings, fabricated from alumina and/or quartz was positioned within a pressure vessel made of a high temperature heat-resistant alloy (16-mm ID, 50-mm OD, 500-mm long). A chromel-alumel thermocouple was inserted into the pressure vessel to monitor the specimen temperature. Specimens were suspended from a quartz specimen holder and were positioned in the constant-temperature section of the tubular furnace. High-purity gases such as CO, CO₂, and H₂, were piped into the reaction chamber through flow meters to obtain the desired composition. To include steam in the exposure environment, water was pumped from a water pump, converted to steam, pressurized, and inserted along with the gas mixture. The effluent from the reactor chamber was condensed to remove the water prior to exhaust. Specimens were exposed to a flowing gas consisting of 53.4% H₂-5.7% CO₂-18.4% CO-22.5% H₂O at 593° C. and 14.3 atm. The gas is a simulation of a reformer outlet gas. The calculated carbon activity of the gas at 593° C. is 2.2, 31, and 89 at 1, 14.3 and 40.8 atm, respectively, based on the reaction CO+H₂═C+H₂O.

Several analytical approaches and techniques were used to evaluate the tested specimens. These included metal weight gain/loss in as-exposed and cleaned conditions, pitting size and density (pits per unit area of surface), pit depth (average depth over significant number of pits), and substrate penetration as determined by metallographic examination. After the specimens were weighed in the as-exposed condition, deposits on the specimens were mechanically removed with a soft brush, and the deposit material was analyzed for metal content, if warranted. The brushed specimens were cleaned ultrasonically to remove residual deposits and then washed in water and dried. Subsequently, the specimens were weighed, and the weight gain/loss was noted. The cleaned specimens were examined for surface pits by optical microscopy. This allowed determination of the number of pits present in different regions of the specimen and the pit density. In addition, the sizes of several pits were measured and averaged to establish an average pit size.

At the end of a given run, several of the cleaned specimens (after weighing and pit measurement) were cut and mounted on the cut faces for metallographic polishing and examination in as-polished and in electrolytically etched (with a 10% acetic acid solution at 10 V for 30 sec) conditions, by optical and/or scanning electron microscopy. Pit depth and substrate penetration thickness were measured in several exposed specimens. Raman spectra were excited with 60 mW of 476-nm radiation from a Kr-ion laser. The incident beam impinged on the sample at an angle=45° from the normal. Scattered radiation was collected along the surface normal with an NA lens and was analyzed with a triple Jobin-Yvon grating spectrometer. All of the spectra were acquired in 300 sec at room temperature.

Ni-base alloys possess better resistance against metal dusting attack than the Fe-base alloys. Without limiting the invention, the difference in the lattice mismatch in catalytic crystallization of carbon may be one reason. The misfit between Ni lattice to graphite lattice (3.6%) is much higher than that between Fe₃C and graphite (0.28%). Lattice of Fe₃C almost perfectly matches the lattice of graphite. This indicates that carbon atoms moving from lattice of Fe₃C to graphite is easier than that from Ni to graphite. Therefore, the precipitation of carbon on surface of Ni has a higher energy barrier than that on surface of Fe₃C, which leads to lower carbon precipitation rate, smaller crystallite size, and lower metal dusting rate. The observed crystallite size of coke on nickel was smaller than that on iron. This difference suggests that Fe₃C is better than Ni in serving as a template for the catalytic crystallization of carbon, and may explain why the metal dusting rate of Fe and Fe-base alloys is higher than that of Ni and Ni-base alloys. The other factor that can affect metal dusting rate is the chemical and mechanical integrity of the oxide layer that develops on the surface of alloys. In this set of examples, the effect of alloy chemistry and phase composition of oxides on surface of Ni-base alloys on metal dusting rates shown. The information on metal dusting rate of several Ni-base alloys was examined in order to establish the best candidate alloys to resist metal dusting corrosion.

### Weight Loss and Pit Development

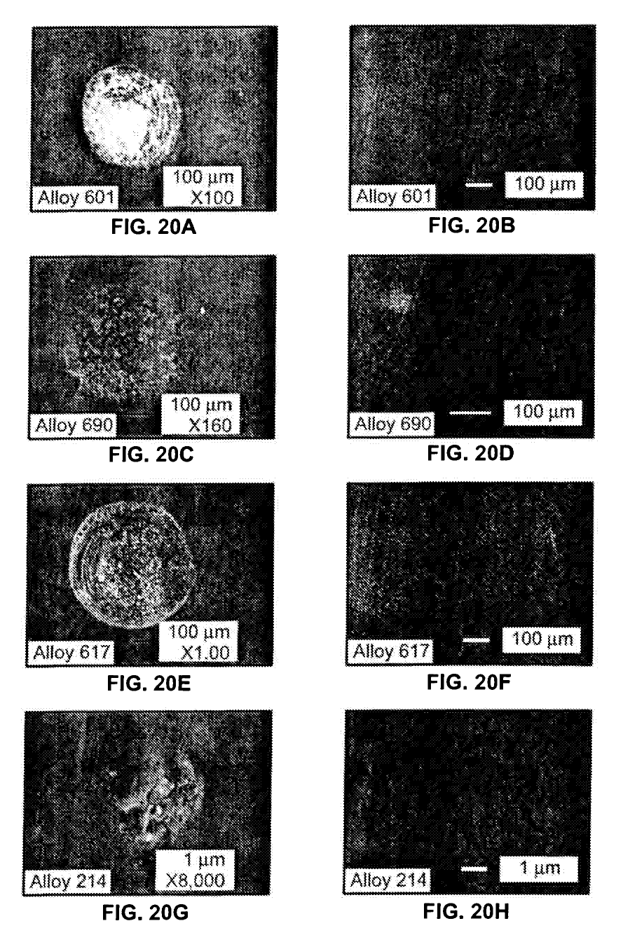

No metal dusting attack was observed for Ni-base alloys in relatively short exposure time of 246 h at 1 atm pressure (Table 4). However, pits were observed on Alloys N06601, N06690, N06617, and N07214 when exposed in the same gas at 593° C. and 14.3 atm (see Table 2). Similar results were obtained when specimens were tested at 40.8 atm (Table 4). FIGS. 20A to 20H show the surface of several indicated alloys after exposure at 593° C. and 1 and 14.3 atm. The carbon activity in the gas is 14 times higher than at 1 atm, which can decrease the incubation time for the initiation of metal dusting pits the alloy surface.

TABLE 4

| UNS number of | Surface characteristics after exposure at | | |
|---|---|---|---|
| alloy | 1 atm | 14.3 atm | 40.8 atm |
| N06601 | Clean surface | Pits | Pits |
| N06690 | Clean surface | Pits | Pits |
| N06617 | Clean surface | Pits | Pits |
| N06025 | Clean surface | Clean surface | Clean surface |
| N07214 | Clean surface | Pits | Pits |
| N06045 | Clean surface | Clean surface | Clean surface |
| N12160 | Clean surface | Clean surface | Clean surface |

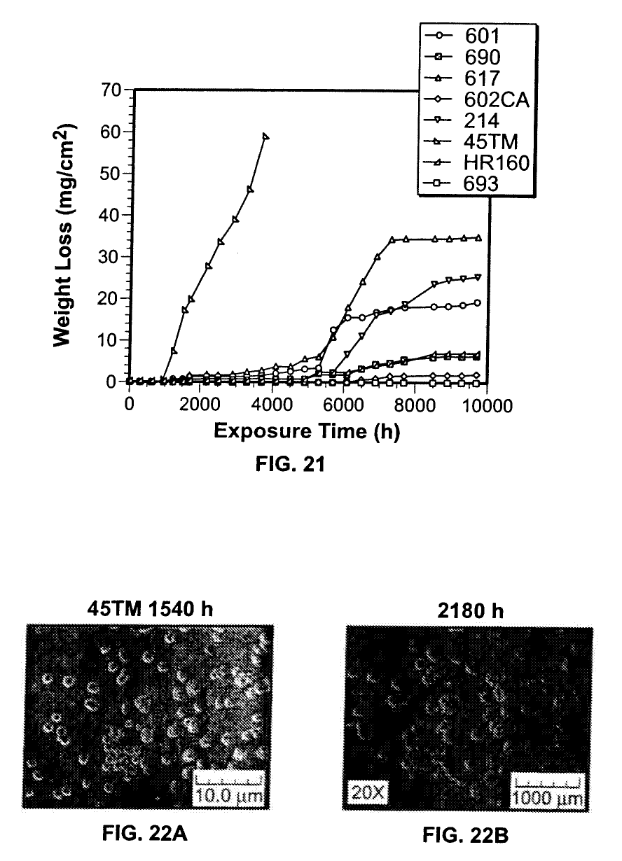

Metal dusting attack, as measured by weight loss, was observed on all the Ni-base alloys when tested for 9700 h in the same gas environment at 593° C. and 14.3 atm (see FIG. 21). However, the weight loss rates for Alloys N06693 and N06045 were very low. Both alloys contain Al, have high Cr content, and low amount of Fe. The weight loss rate for Alloy N06045 was the highest among the Ni-base alloys used in the study, although the Cr content in this alloy is fairly high. The iron content in Alloy N06045 is also the highest among these alloys. The weight loss rate of Alloy N06601 was also high. The iron content in Alloy N06601 is the second highest among these alloys. The results indicate that addition of iron to the Ni-base alloys results in substantial decrease in incubation time for the onset of metal dusting. When Fe content in the alloy >10 wt. %, the alloy is readily attacked as evidenced by numerous pits on the exposed surfaces of the alloy specimens. The weight loss rate for cobalt-containing Alloy N06617 is the second highest among these alloys. Mo addition in this alloy did not improve its resistance to metal dusting corrosion. The other cobalt-containing Alloy N12160 also exhibited metal dusting degradation, although it contained 28% Cr. Therefore, Co addition in alloys is also not beneficial in resisting metal dusting. The Cr content in Alloy N07214 is the lowest among these alloys and its weight loss rate was also high although it contained aluminum. High Cr content in alloys seems essential but not entirely sufficient for preventing metal dusting corrosion in Ni-base alloys.

Even though weight loss data developed for various alloys are useful in evaluation and ranking of the alloys from their susceptibility to metal dusting attack, such data may indicate the protective capacity of the surface oxide scale and probably represent only an average behavior for the alloy in a given exposure environment and temperature. Since the corrosion damage in the alloy occurs by nucleation of pits on the surface and their growth inward, it is essential to develop an understanding of the morphology of pits (such as pit size, pit distribution, pit depth, etc.) on the alloy surface and of the maximum growth rate of the pits to evaluate the ultimate damage of component failure under a given set of exposure (process) conditions.

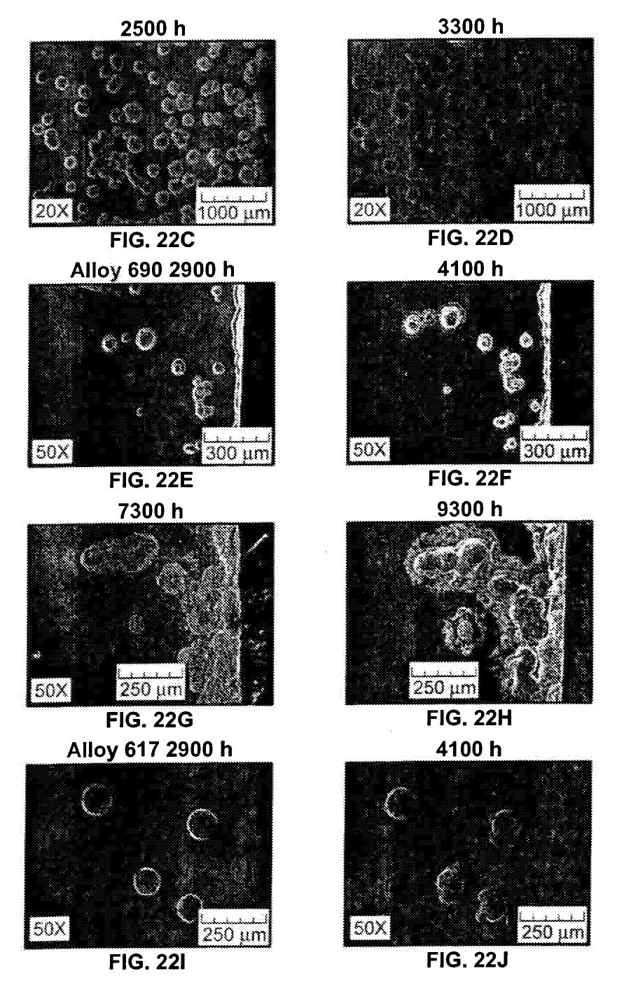

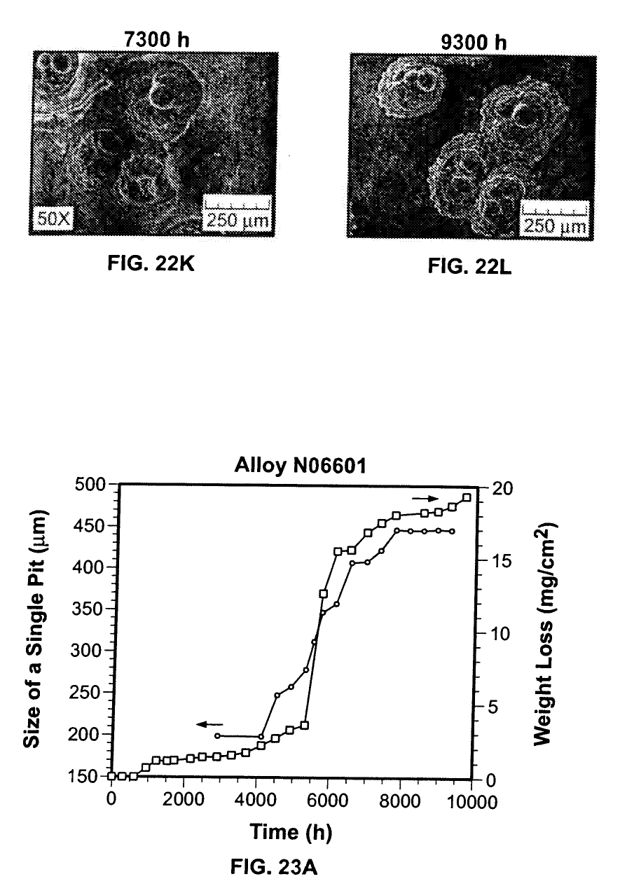

During the course of the 9700 h exposure experiment, the specimens were retrieved periodically and SEM photomicrographs taken of different regions all the specimens to characterize and monitor their growth as a function of exposure time. FIGS. 22A-22C show the SEM photomicrographs of pit development in alloys N06045, N06690, and N06617 after exposure for different times in the metal dusting environment at 593° C. and 14.3 atm.

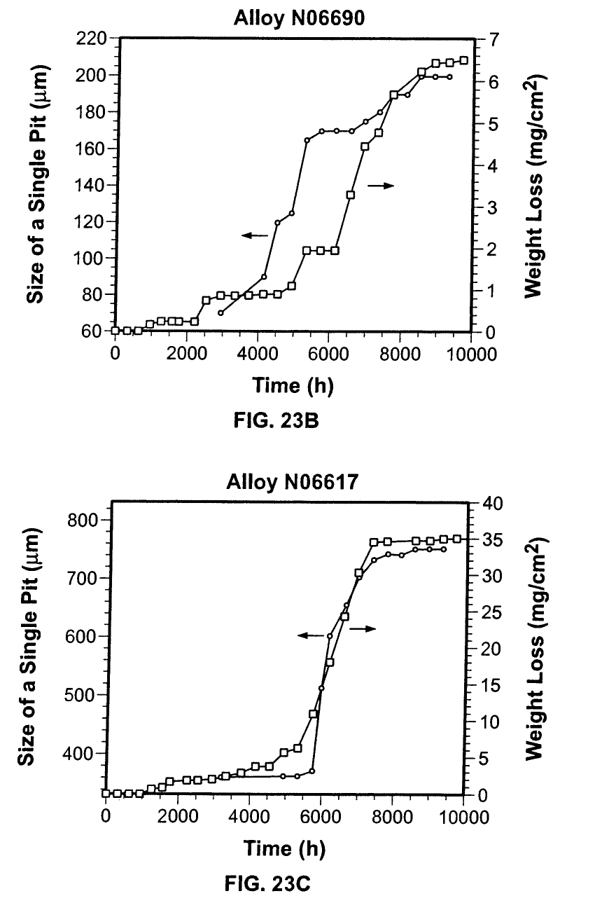

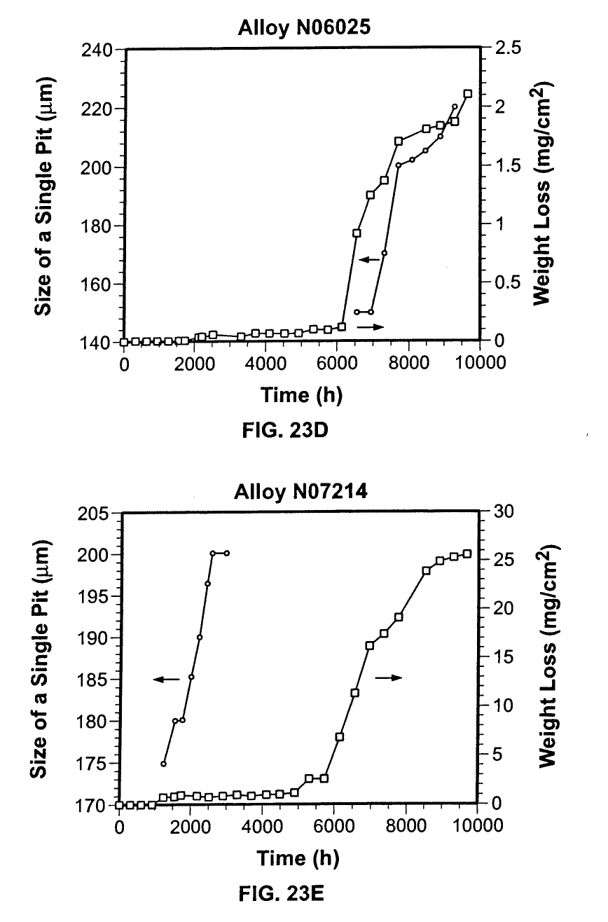

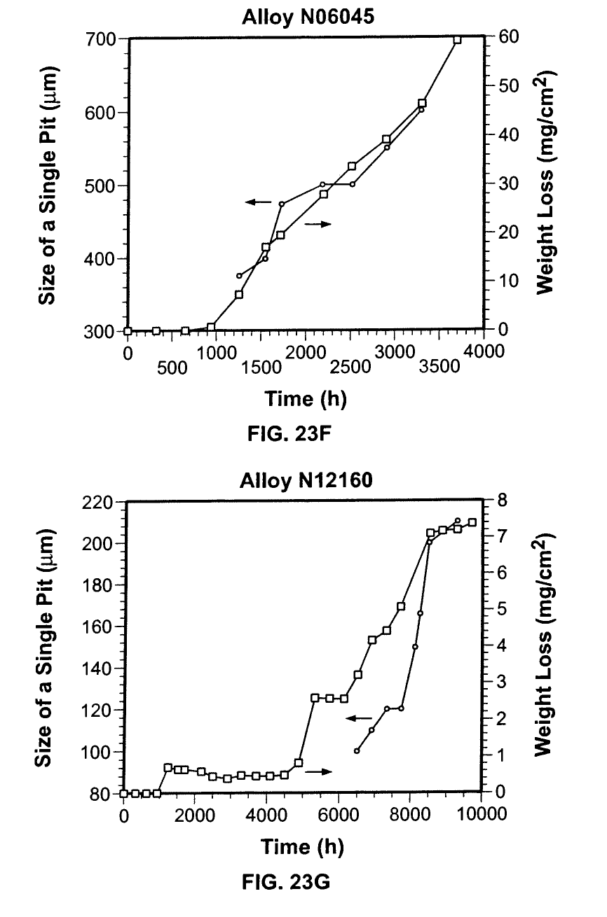

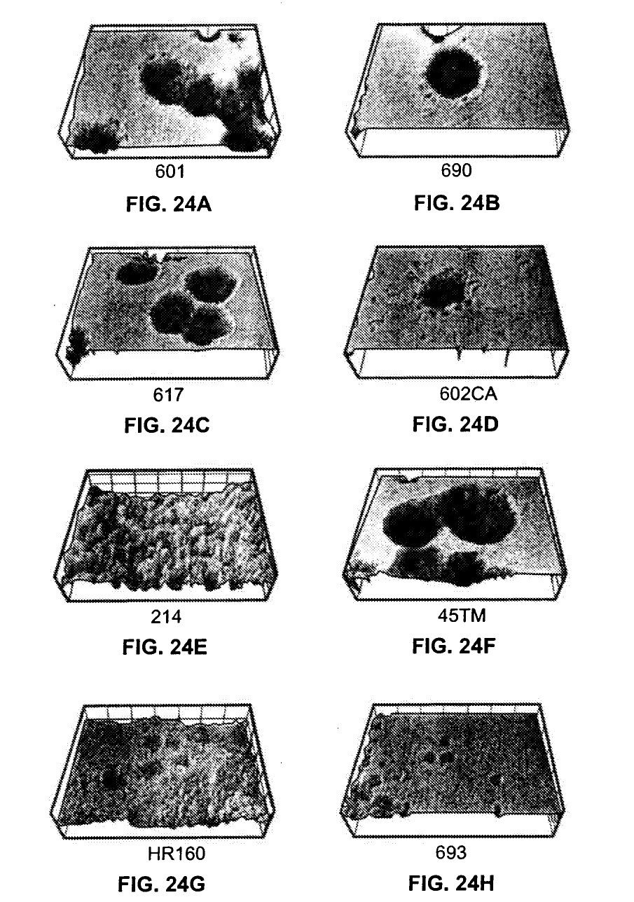

The dimension of a single pit (for each alloy) was measured as a function of exposure time and correlated the pit size data with measured weight change for the corresponding alloys. Table 5 lists the maximum pit size and weight loss for various alloys. FIGS. 23A-23G show the measured pit size and weight change for all the alloys used in the present study. The plots, for most of the alloys, indicate a good correlation between the growths in the size of an arbitrarily selected pit on the surface of the alloy with the measured weight change. Furthermore, absolute increase in pit size as a function of exposure time is different for different alloys. For example, the pit size increases from 200 to 450 μm as the exposure time increases from 4000 to 9300 h for Alloy N06601. The corresponding increases for Alloy N06690 are 70 to 200 μm for time increase of 2900 to 9300 h. Similar information for other alloys can be obtained from the curved shown in FIGS. 23A-24G.

TABLE 5
Maximum pit size and weight loss for
alloys after 9,700-h exposure.

| UNS number | Weight loss | Pit depth | Pit diameter | Ratio of pit depth |
|---|---|---|---|---|
| of alloy | (mg/cm²) | (μm) | (μm) | to pit diameter |
| N06601 | 19.5 | 110 | 450 | 0.244 |
| N06690 | 6.5 | 147 | 440 | 0.334 |
| N06617 | 35.1 | 201 | 887 | 0.227 |
| N06025 | 2.1 | 96 | 374 | 0.256 |
| N07214 | 25.6 | Uniformly corroded | | |
| N06045¹ | 59.1 | 141 | 600 | 0.235 |
| N12160 | 7.3 | 13 | 210 | 0.062 |
| N06693 | 0.1 | 37 | 99 | 0.374 |

¹The alloy was exposed only for 3,300 h whereas the others were exposed for 9,700 h.

The behavior of alloy N07214 is somewhat different from that of others, since there is a poor correlation between the size increase of a single pit in this alloy with its weight change. The reason for this poor correlation is because this alloy contains low (15.9 wt. %) concentration of Cr and a high (3.7 wt. %) concentration of Al and develops a large number of small pits. The nucleation and growth of a large number of small pits with low growth rates reflects in the weight change but on the growth rate of an individual pit. The alloy exhibited a uniform coverage after 3000 h exposure and the size of an individual pit could not be measured. Alloy N06045 exhibited an extremely rapid growth rate for the pit (380 to 600 μm during 1400 to 3400 h) and its exposure was terminated after 3800 h. The cause for the rapid increase in pit growth in this alloy can be attributed to higher (26.7 wt. %) Fe content of the alloy. FIGS. 24A-24H show a comparison of SEM photomicrographs of surfaces of several alloys after exposure at 9700 h at 593° C. to the metal dusting environment. It is evident from this figure that Alloy N07214 develops a rough surface, attributed to multitude of small and probably shallow pits.

### Phase Composition of Scales

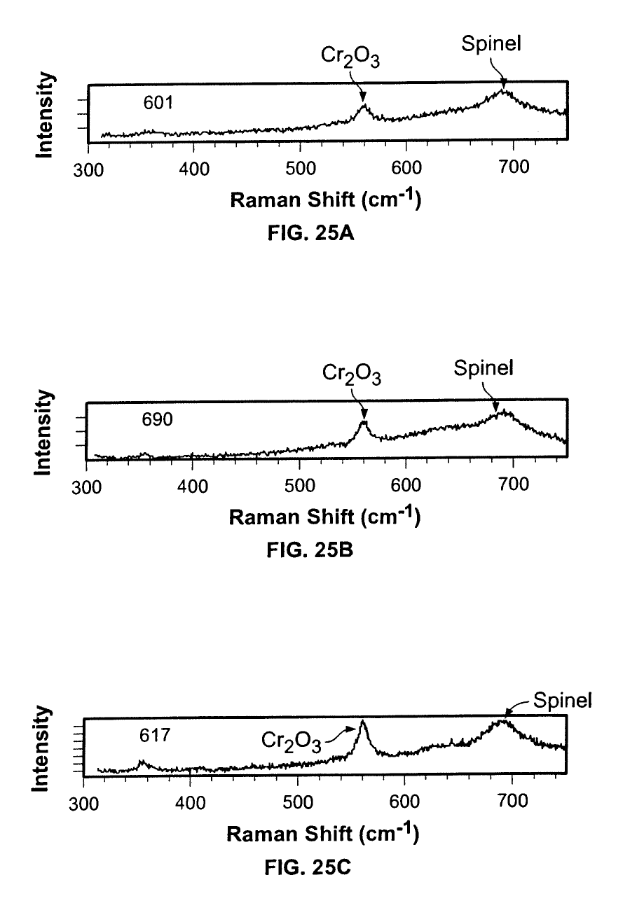

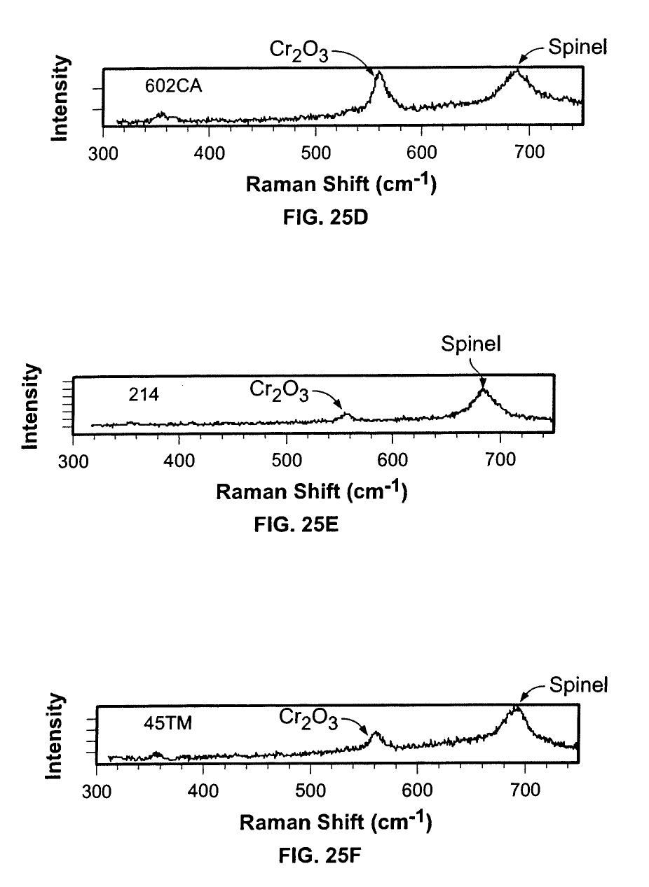

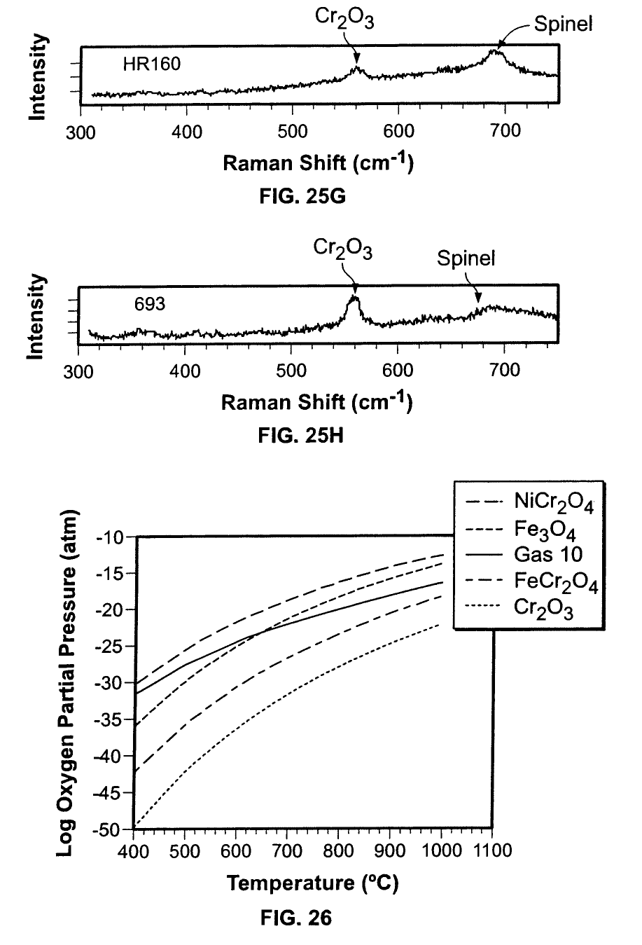

Raman spectra were excited with 60 mW of 476-nm radiation from a Kr-ion laser. The scattered light was analyzed with a triple Jobin-Yvon grating spectrometer. All of our spectra were acquired in 300 sec at room temperature. Raman spectra were developed on alloys after exposure at 100 and 2900 h. FIGS. 25A-25H shows a comparison of Raman spectra obtained on the indicated alloys after exposure at 2900 h to the metal dusting environment.

Raman spectra showed that the intensity of Cr₂O₃ band at about 560 cm⁻¹ was low for both Alloys N07214 and N06045 and the relative intensity of spinel is high in both the alloys. Spinel phase in the scale is not as good as Cr₂O₃ scale in preventing alloys from metal dusting corrosion, which probably is the cause for these two alloys to undergo metal dusting. The low Cr₂O₃ content on surface of Alloy N07214 may be due to the low Cr content in alloy. On the contrary, Cr content in N06045 is relatively high but the Fe content is also high. The presence of high Fe content may stabilize the Fe-containing spinel phase rather than Cr₂O₃, thereby subjecting the alloy to metal dust. The fit to the broad Raman band for alloy N06045 is due to disordered chromium oxide with oxygen vacancies. NiCr₂O₄ spinel is not thermodynamically stable in a reducing environment used in our study and therefore, could not form at 593° C. (FIG. 26). The results suggest that an alloy with a high Cr content (with or without Al) and low Fe content may stabilize Cr₂O₃ and/or a spinel phase with high Cr content, thereby prolong the incubation period for, the onset of metal dusting and subsequent propagation of the process leading to metal wastage.

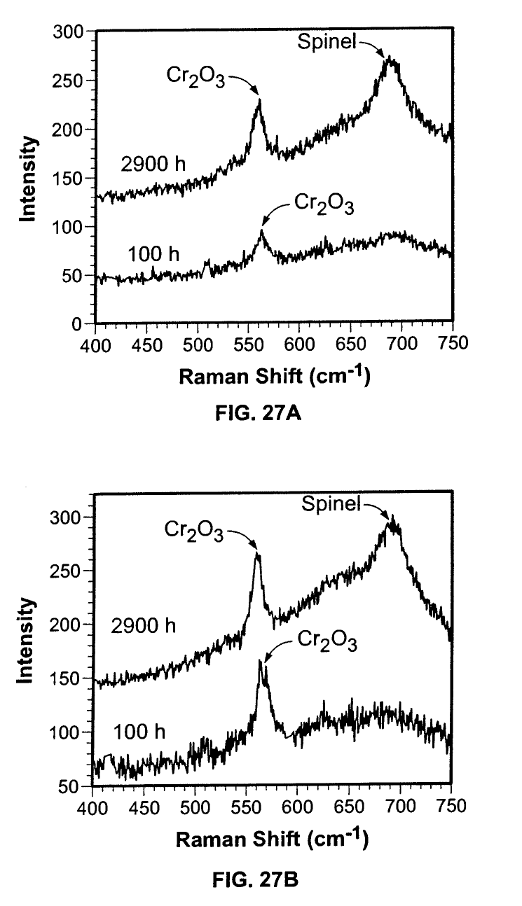

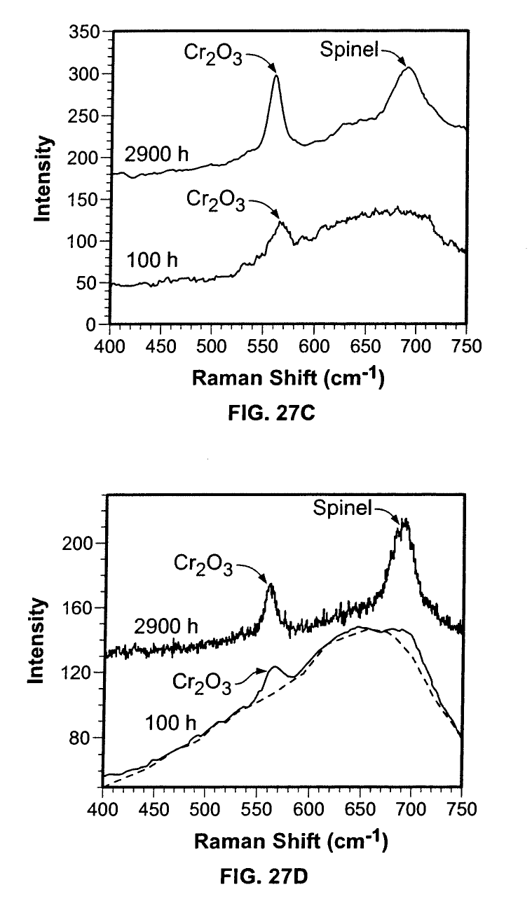

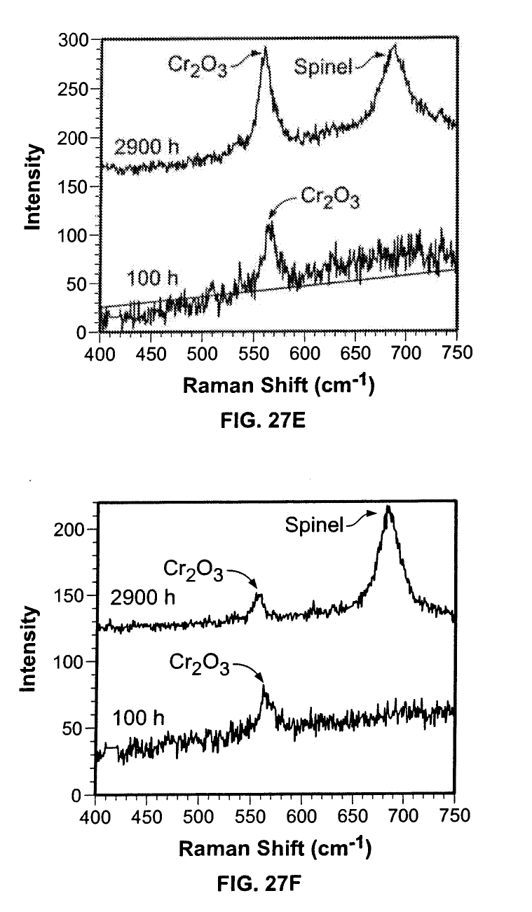

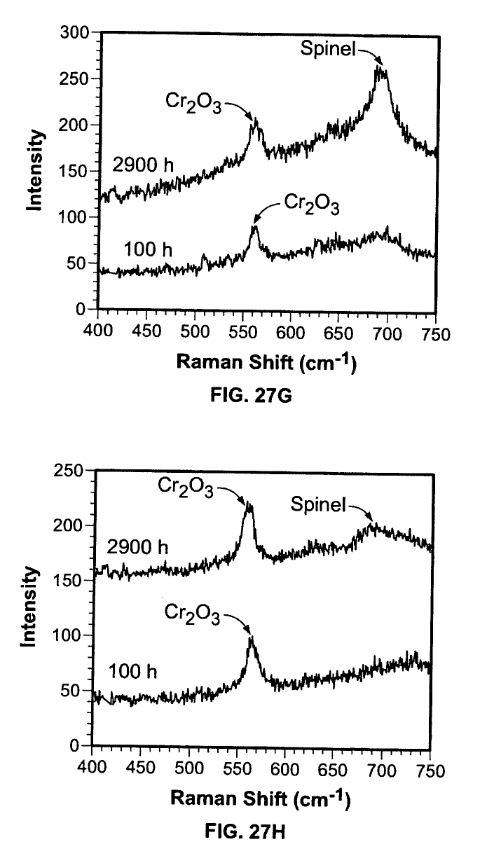

Phase composition of oxide scales that developed on surface of alloys changed with exposure time. FIGS. 27A-27H show the intensity differences of Raman bands for Cr₂O₃ and spinel phases in oxide scale on surfaces of several alloys after 100 and 2900 h exposure. When the alloys were exposed for only 100 h, Cr₂O₃ was the major phase in oxide scales that developed on surface of alloys. However, after 2900 h exposure, the intensity of spinel band in Raman spectra increased significantly. On Alloy N07214, spinel became the major phase after exposure for 2900 h, whereas Cr₂O₃ was the major phase in the oxide scale when the alloy had been exposed for 100 h.

The increasing amount of spinel phase in oxide scales over longer exposure time can be attributed to the outward diffusion of Fe from the alloy substrate. At early stages, Cr-rich oxide forms on the surface of alloys. However, as the outward transported Fe gets incorporated into the scale, spinel phase becomes dominant as was observed in the Raman spectra. The diffusion rate of Fe and its incorporation in the scale to form the spinel phase would have a pronounced effect on the incubation time for the onset of metal dusting in the alloy. As the transported Fe gets incorporated into the spinel phase, the protective capacity of the spinel is reduced, since the inward migrating carbon can easily reduce the high-iron containing spinel.

The Raman analysis showed that the spinel band intensity was the lowest for Alloy N06693 after 2900 h exposure in the environment used in the study at 593° C. and 14.3 atm, indicating that the incubation time for the onset of metal dusting for this alloy will be significantly greater than most of the others studied in this program.

In accordance with the principals of the present invention, a non-limiting model explains the function of aluminum to resist metal dusting corrosion as shown in (FIGS. 18A and 18B) as discussed hereinbefore. There may be defects in oxide scale that develop on surface of alloys. When carbon deposits on surface of alloys during exposure to metal dusting environment, carbon diffuses through these defects and reduce the spinel phase to Fe₃C and/or Ni metal. These particles form channels for transferring carbon through oxide scale. Oxygen may also diffuse through the channels resulting in formation of additional chromium oxide. However, the carbon diffusion rate is probably higher than that of oxygen and formation of additional chromium oxide beneath the carbon channel may not be feasible. Therefore, carbon can continue to diffuse into alloys through the channels and finally form dusting pits. When aluminum is added to the alloy, alumina scale usually forms underneath chromium oxide scale. There may be two effects of alumina to resist metal dusting corrosion. First, the carbon transferred through the channel may not be able to penetrate through alumina layer because alumina is much more stable than spinel. Second, the partial pressure of oxygen to form Al₂O₃ (3.6×10⁻⁵⁷ atm) is much lower than that of Cr₂O₃ (2.6×10⁻³⁷ atm) at 593° C. A thin layer of alumina scale can form (even with limited oxygen transport through the channel) beneath the carbon diffusion channel, thereby reducing the growth of metal dusting pits.

It should be understood that various changes and modifications referred to in the embodiment described herein would be apparent to those skilled in the art. Such changes and modifications can be made without departing from the spirit and scope of the present invention.

What is claimed is:

1. An article of metallic material manufacture for reducing susceptibility to metal dusting degradation, comprising a nickel base alloy comprising (in weight percentage) Cr of about 22-29, Al of about 2.0-3.5, Fe of about 0-1.0; Ti of about 0-0.3, Zr of about 0.1-0.2, Y of about 0-0.1 and the balance Ni.

2. The article as defined in claim 1 wherein the nickel alloy contains iron in an amount, by weight percentage, less than about one percent.

3. The article as defined in claim 1 further including a multi-layer tubing for passage of material therein and said tubing including a copper layer adjacent said nickel base alloy.

4. The article as defined in claim 3 wherein the multi-layer tubing includes an in-situ-developed chromium oxide layer.

5. The article as defined in claim 3 further including an aluminum oxide layer disposed adjacent the chromium oxide layer.

6. The article as defined in claim 3 wherein the multi-layer tubing further includes at least one of an aluminum oxide layer, a Fe (Cr₁₋ₓ Feₓ)₂O₄ layer with high chromium to iron ratio, and a substrate consisting essentially of copper, a Ni-based alloy layer and an Fe-based alloy layer.
